(19) United States
(12) Patent Application Publication
(10) Pub. No.: US 2011/0115242 A1
(43) Pub. Date: May 19, 2011

(54) Snow shovel

(76) Inventor: John McNab, Winnipeg (CA)

(21) Appl. No.: 12/591,233

(22) Filed: Nov. 13, 2009

(51) Int. Cl. E01H 5/02; A01B 1/02

(52) U.S. Cl. 294/54.5; 37/285

(57) ABSTRACT

A snow shovel has a blade ending in a front leading cutting edge of wedge cross section. Rear vanes having coplanar bottom surfaces aligned with the cutting edge, terminate in a rounded trailing edge parallel to the leading edge. The blade leading edge can pivot upward about the trailing edge allowing the leading edge to clear irregular ground. The rear vanes cut through the snow to the ground surface, allowing minimal clearance by the leading edge and close snow removal.

The invention is directed to a snow shovel having a blade with bottom ribs or vanes. These ribs or vanes both cut into the snow and allow the shovel to glide over uneven surfaces beneath the snow.

Although the invention is described and referred to specifically as it relates to a blade having associated rear vanes for snow removal, it will be understood that the principles of this invention are equally applicable to similar devices, structures and methods for snow removal and accordingly, it will be understood that the invention is not limited to such devices, structures, machines and methods for snow removal.

### BACKGROUND

In general snow shovels and scoops are used to clear paths and drives and the like, which are usually asphalt, concrete or stone, in areas where the snow lies for some time. The earth freezes and thaws with temperature variation, especially at the start and end of winter. The resulting frost heaves the asphalt, concrete or stone of the path or drive, breaking the smooth surface. Snow shovels and scoops inevitably collide and jar with the heaved elements, to the annoyance of the user. The applicant has found that the modified shovel of the invention collides much less frequently, and glides much more smoothly over frost heaved surfaces.

### PRIOR ART

U.S. Pat. No. 1,264,433, 30 Apr. 1918, Posten, teaches a shovel having angled runners to carry the blade above surface obstructions. U.S. Pat. No. 2,545,226, 13 Mar. 1951, Claude, teaches a leaf scoop with front guide bar having ridges and grooves for ground contact. U.S. Des. Pat. 411,420, 22 Jun. 1999, Rose, teaches a snow shovel with longitudinal grooved ridges curved at the front, which could be used to raise the blade edge over uneven surface. U.S. App. 2005/0184542, 25 Aug. 2005, Moreschini et al. teaches a shovel having a wedge protuberance extending two inches backward and extending across the entire front of the blade, on encountering uneven surface, the handle is tilted down raising the front of the wedge and allowing it to glide over uneven surface.

U.S. Des. Pat. 187,874, 10 May 1960, Cross, teaches a snow plough blade backed by curved strips which would allow the blade to be raised to glide over uneven surfaces. Canadian Pat. 687,138, 26 May 1964, teaches a snow scoop with skids either tangential to the blade or further back, both sets of skids are used to raise the blade over uneven surface. U.S. Pat. No. 3,218,738, 23 Nov. 1965, Bowerman, teaches a roof snow scoop with skids at the blade edge to space the blade edge from the roof. U.S. Des. Pat. 242,761, 21 Dec. 1976, DiCarlo, teaches a snow scoop with a circular disc side, which allows the blade edge to be raised over uneven, surface. U.S. Pat. No. 4,153,287, 8 May 1979, Towsend, teaches a shovel blade with semirigid bristles projecting from its bottom, letting the blade edge clear uneven surface. U.S. Pat. No. 4,386,474, 7 Jun. 1983, Mechavich et al., teaches a snow hoe shoe (roof rake) with hoop shoes at the blade edge to space the blade edge from the roof. U.S. Pat. No. 5,511,327, 30 Apr. 1996, Jurkowski et al., teaches a shovel blade with a squeegee projecting from its bottom, letting the blade edge clear uneven surface. U.S. Pat. No. 5,676,413, 14 Oct. 1997, Hauck, teaches a roof rake with paired rollers at the blade edge, to space the blade edge from the roof. U.S. Pat. No. 5,845,949, 8 Dec. 1998, to Vosbikian, teaches a snow shovel with a recessed scraping (blade) edge to avoid surface contact. U.S. Pat. No. 5,956,873, 28 Sep. 1999, Hess, teaches a roof rake with paired semicircular guides near the blade edge, to space the blade edge from the roof.

U.S. Pat. No. 4,193,626, 18 Mar. 1980, Vondracek, teaches a scoop with a front edge angled flange to aid in gliding over uneven surfaces.

U.S. Pat. No. 173,209, 8 Feb. 1876, Campbell, teaches a scoop with runners to prevent the blade edge touching the surface. U.S. Pat. No. 180,543, 1 Aug. 1876, Campbell, teaches a scoop with runners to prevent the blade edge touching the surface, with small wheels at the leading edge. U.S. Pat. No. 258,260, 23 May 1882, Staples, teaches a scoop with runners U.S. Pat. No. 289,131, 27 Nov. 1883, Patten, teaches a box scoop with runners, the blade edge is lowered in use. U.S. Pat. No. 787,921, 25 Apr. 1905, Hooper, teaches a scoop with runners. U.S. Pat. No. 1,445,952, 20 Feb. 1923, Hooper, teaches a scoop with runners. U.S. Pat. No. 1,678,135, 24 Jul. 1928, Crosman et al., teaches a scoop with runners. U.S. Pat. No. 1,766,691, 24 June 1930, Rugg, teaches a scoop with flat runners, the scoop is tilted down to collect snow. U.S. Pat. No. 2,933,836, 26 Apr. 1960, McKinley, teaches a scoop with a flush front edge and curved runners to ease tipping or dumping snow. U.S. Des. Pat. 271,369, 15 Nov. 1983, Gesner, teaches a scoop with runners. U.S. Pat. No. 5,271,169, 21 Dec 1993, Konsztowicz, teaches a snow pusher with runners, the blade may be raised to avoid snagging the ground.

U.S. App. 2005/0230985, 20 Oct. 2005, Thiele, Jr., teaches a shovel with a scalloped blade edge.

In general as is ascertained from the toboggan art, the function of runners, skids, ridges, or guides whether curved, bevelled, or flat is to reduce the frictional surface in contact with the snow, and thus the friction itself. In combination with a shovel or scoop blade, they would lift the blade edge above the snow surface, and not clear snow from the ground surface. Moreschini's flat wedge bottom pushes the blade upward toward the snow and away from the ground surface. None of the prior art teaches a snow shovel which both cuts down to the ground surface and glides smoothly over ground irregularities.

### DESCRIPTION OF THE INVENTION

In one broad aspect the invention is directed to a snow removal device, most preferably a shovel, although some lighter forms of scoop may embody the invention, comprising a blade having a horizontal ground engaging leading edge extending across the front of the blade and an array of spaced apart vanes protruding from the rear of the blade, substantially perpendicular to the blade and the leading edge. The vanes have bottom surfaces lying in a plane aligned with the leading edge, which is use is normally substantially horizontal. Typically both blade and vanes are thin. Preferably the leading edge comprises a horizontal cutting edge extending across the front of the blade, and a wedge extending rearward from the cutting edge. The wedge has a top surface angled upward and rearward of the cutting edge, a planar bottom surface extending rearward from the cutting edge. The top surface of the wedge comprises the front surface of the blade, and the bottom surface of the wedge comprises the bottom surfaces of the vanes and the bottom surface of the blade. Usually the front surface of the blade curves upward and rearward. Usually the bottom surface of the blade is coplanar with the bottom surfaces of the vanes, unless the bottom surface of the blade is vanishingly thin. Preferably the rear ends of the bottom surfaces of the vanes are aligned substantially parallel to the leading edge and the rear ends form a trailing edge. The trailing edge can be used to pivot blade, wedge, leading edge and cutting edge upward by the user. More preferably the rear ends of the bottom surfaces are rounded. Typically the blade is a sheet having opposed front and rear surfaces. Preferably the blade is concave forward, curving upward from the leading edge. Conveniently the blade is part of the inner surface of a cylinder, although this is not essential, as those skilled in the art appreciate. Preferably the blade can pivot about the trailing edge.

In a second broad aspect the invention is directed to an improved snow removal device having blade and attached shaft with handle, the improvement comprises the blade having a horizontal ground engaging leading edge extending across the front of the blade and an array of spaced apart vanes protruding from the rear of the blade, substantially perpendicular to the blade and the leading edge. The vanes have bottom surfaces lying in a plane aligned with the leading edge, which is use is normally substantially horizontal. Typically both blade and vanes are thin. Preferably the leading edge comprises a horizontal cutting edge extending across the front of the blade, and a wedge extending rearward from the cutting edge. The wedge has a top surface angled upward and rearward of the cutting edge and a planar bottom surface extending rearward from the cutting edge. The top surface of the wedge is the front surface of the blade, and the bottom surface of the wedge comprises the bottom surfaces of the vanes and the bottom surface of blade. Usually the front surface of the blade curves upward and rearward. Usually the bottom surface of the blade is coplanar with the bottom surfaces of the vanes, unless the bottom surface of the blade is vanishingly thin. Preferably the rear ends of the bottom surfaces of the vanes are aligned substantially parallel to the leading edge and the rear ends form a trailing edge. The trailing edge can be used to pivot blade, wedge, leading edge and cutting edge upward by the user. Preferably the rear ends of the bottom surface are rounded. Typically the blade is a sheet having opposed front and rear surfaces. Typically the blade is concave forward, curving upward from the leading edge. Conveniently the blade is part of the inner surface of a cylinder, although this is not essential, as those skilled in the art appreciate. Preferably the blade can pivot about the trailing edge.

In a third broad aspect the invention is directed to a snow removal device comprising a blade, attached shaft with handle, and the blade has a horizontal ground engaging leading edge extending across the front of the blade and an array of spaced apart vanes protruding from the rear of the blade and substantially perpendicular to the blade and the leading edge, the vanes having bottom surfaces lying in a plane aligned with the leading edge, which is use is normally substantially horizontal. Typically both blade and vanes are thin. Preferably the leading edge comprises a horizontal cutting edge extending across the front of the blade, and a wedge extending rearward from the cutting edge. The wedge has a top surface angled upward and rearward of the cutting edge and a planar bottom surface extending rearward from the cutting edge. The top surface of the wedge is the front surface of the blade, and the bottom surface of the wedge comprises the bottom surfaces of the vanes and the bottom surface of the blade. The rear ends of the bottom surfaces of the vanes are aligned substantially parallel to the leading edge to form a trailing edge. The rear ends of the bottom surface are rounded. The blade is a sheet having opposed front and rear surfaces. The blade is concave forward, curving upward from the leading edge. Conveniently the blade is part of the inner surface of a cylinder, although this is not essential, as those skilled in the art appreciate. The blade can pivot about the trailing edge.

### BRIEF DESCRIPTION OF THE DRAWINGS

FIG. 1 shows a sectional side elevational view of an embodiment of the invention.

FIG. 2 shows a detail of the embodiment of FIG. 1.

FIG. 3 shows a top plan view of the embodiment of FIG. 1.

FIG. 4 shows a rear elevational view of the embodiment of FIG. 1.

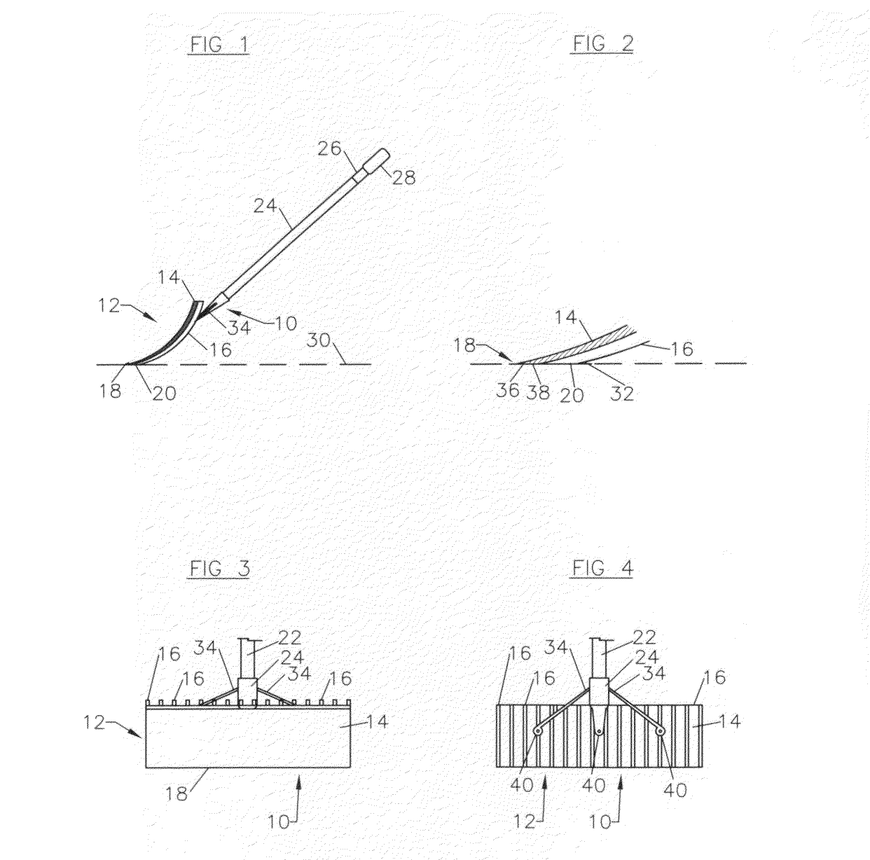

### DESCRIPTION OF THE PREFERRED EMBODIMENT

The invention is illustrated by reference to preferred embodiments thereof. Numeral 10 denotes the snow shovel of the invention. Snow shovel 10 has blade 12 having cylindrical sheet 14 which has an array of vanes 16 projecting radially from the rear surface. Cylindrical sheet 14 has leading ground engaging edge 18 from which the bottom edges 20 of vanes 16 extend rearward. Leading edge 18 has cutting edge 36 and base 38 substantially coplanar with bottom edges 20, which are aligned in a plane. Bottom edges 20 extend rearward to trailing edge 32. Leading edge 18 normally is a wedge with an angle of about 20° extending rearward from cutting edge 36, which is not critical, from about 15° or less to about 25° or more work. Socket 22 is attached to the rear of blade 12, both directly and by struts 34, socket 22 and struts 34 are attached to cylindrical sheet 14 by conventional fasteners 40, which may be screws, nuts and bolts, pop rivets and the like. Socket 22 receives shaft 24, typically cylindrical and about 1 inch (2% cm) diameter. At the outer end of shaft 24′is handle socket 26 and conventional handle 28. In use leading edge 18 and cutting edge 36 slide along ground surface 30, shown in ghost, removing snow and ice, while surfaces 38 and 20 skim along ground surface 30. Blade 12 as shown is a portion of reinforced plastic sewer pipe, typically from 12 to 18 inches (30 to 45 cm) diameter and ⅛ inch (3 mm) thick, measuring about 18 to 24 inches (about 45 to 60 cm) wide, with vanes 16 projecting about ½ to 1 inch (1 to 2½ cm) from sheet 14, vanes 16 are about 1/16 to inch (1½ to 3 mm) thick and evenly spaced about 1 inch (2½ cm) apart. Surface 38 is typically ¼ inch (6 mm) from front to rear, while surface 20 is about 1½ inch (3¾ cm) from front to rear. Curved sheet 14 generally subtends an angle of a third circumference) (120°) but this is not critical. In use of shaft 24 should approximate 45° to the horizontal or vertical for convenience, at this angle cutting edge 36 slides along ground surface 30, while surfaces 38 and 20 skim along either level or at a slight rearward upward angle. In the presence of bumps handle 26 is lowered, cutting edge 36 is raised pivoting upward about trailing edge 32 of surface 20, which is preferably rounded. At this angle cutting edge 36 clears most bumps, while surface 20 of vanes 16 glide over them. The configuration of the leading ground engaging edge of the blade and the vanes immediately rearward thereof has been found very effective in gliding over snow covered ground, level and irregular, while removing the snow.

The above-described details, materials and components are meant as illustrative only and not in a limiting sense.

As those skilled in the art would realize these preferred described details and materials and components can be subjected to substantial variation, modification, change, alteration, and substitution without affecting or modifying the function of the described embodiments.

Although embodiments of the invention have been described above, it is not limited thereto, and it will be apparent to persons skilled in the art that numerous modifications and variations form part of the present invention insofar as they do not depart from the spirit, nature and scope of the claimed and described invention.

I claim:

1. A snow removal device comprising a blade having a horizontal ground engaging leading edge extending across the front of said blade and an array of spaced apart vanes protruding from the rear of said blade and substantially perpendicular to said blade and said leading edge, said vanes having bottom surfaces lying in a plane aligned with said leading edge.

2. Device of claim 1, wherein said leading edge comprises a horizontal cutting edge extending across the front of said blade, and a wedge extending rearward from said cutting edge, said wedge having a top surface angled upward and rearward of said cutting edge and a planar bottom surface extending rearward from said cutting edge.

3. Device of claim 2, wherein said top surface of said wedge is comprises the front surface of said blade, and said bottom surface of said comprises the bottom surfaces of said vanes and the bottom surface of said blade.

4. Device of claim 1 wherein the rear ends of said bottom surfaces of said vanes are aligned substantially parallel to said leading edge and said rear ends form a trailing edge.

5. Device of claim 4, wherein said rear ends of said bottom surface are rounded.

6. Device of claim 1, wherein said blade is a sheet having opposed front and rear surfaces.

7. Device of claim 1, wherein said blade is concave forward, curving upward from said leading edge.

8. Device of claim 7, wherein said blade is part of the inner surface of a cylinder.

9. Device of claim 4, wherein said blade can pivot about said trailing edge.

10. In a snow removal device having blade and attached shaft with handle
the improvement comprising said blade having a horizontal ground engaging leading edge extending across the front of said blade and an array of spaced apart vanes protruding from the rear of said blade and substantially perpendicular to said blade and said leading edge, said vanes having bottom surfaces lying in a plane aligned with said leading edge.

11. Device of claim 10, wherein said leading edge comprises a horizontal cutting edge extending across the front of said blade, and a wedge extending rearward from said cutting edge, said wedge having a top surface angled upward and rearward of said cutting edge and a planar bottom surface extending rearward from said cutting edge.

12. Device of claim 11, wherein said top surface of said wedge is the front surface of said blade, and said bottom surface of said wedge comprises the bottom surfaces of said vanes and the bottom surface of said blade.

13. Device of claim 10 wherein the rear ends of said bottom surfaces of said vanes are aligned substantially parallel to said leading edge and said rear ends form a trailing edge.

14. Device of claim 13, wherein said rear ends of said bottom surface are rounded.

15. Device of claim 10, wherein said blade is a sheet having opposed front and rear surfaces.

16. Device of claim 10, wherein said blade is concave forward, curving upward from said leading edge.

17. Device of claim 16, wherein said blade is part of the inner surface of a cylinder.

18. Device of claim 13, wherein said blade can pivot about said trailing edge.

19. A snow removal device comprising a blade, attached shaft with handle wherein said blade has a horizontal ground engaging leading edge extending across the front of said blade and an array of spaced apart vanes protruding downward from the rear of said blade and substantially perpendicular to said blade and said leading edge, said vanes having bottom surfaces lying in a plane aligned with said leading edge.

20. Device of claim 19, wherein said leading edge comprises a horizontal cutting edge extending across the front of said blade, and a wedge extending rearward from said cutting edge, said wedge having a top surface angled upward and rearward of said cutting edge and a planar bottom surface extending rearward from said cutting edge
wherein said top surface of said wedge is the front surface of said blade, and said bottom surface of said wedge comprises the bottom surfaces of said vanes and the bottom surface of said blade
and said rear ends of said bottom surfaces of said vanes are aligned substantially parallel to said leading edge to form a trailing edge, and;
said rear ends of said bottom surface are rounded, and said blade is a sheet having opposed front and rear surfaces, and said blade is concave forward, curving upward from said leading edge,
and said blade can pivot about said trailing edge.
